(19) United States
(12) Patent Application Publication
(10) Pub. No.: US 2002/0167243 A1
(43) Pub. Date: Nov. 14, 2002

(54) Stator bobbins for axial winding

(75) Inventors: Alex Horng, Kaohsiung (TW); Ching-Shen Hong, Kaohsiung (TW)

Correspondence Address: Bacon & Thomas, 4th Floor, 625 Slaters Lane, Alexandria, VA, 22314, US

(73) Assignee: Sunonwealth Electric Machine Industry Co., Ltd., Kaohsiung (TW)

(21) Appl. No.: 09/852,081

(22) Filed: May 10, 2001

(51) Int. Cl. H02K 37/00

(52) U.S. Cl. 310/194

(57) ABSTRACT

A stator bobbin for axial winding is made from insulating material and includes a first disc, a second disc, and a connecting tube that connects the first disc with the second disc. The connecting tube has a central hole and a space for winding is defined between the first disc and the second disc. A first pole plate is attached to an outer side of the first disc and a second pole plate is attached to an outer side of the second disc. A distance between an outer end of the inner side of the first disc and an outer end of the inner side of the second disc is greater than that between an inner end of the inner side of the first disc and an inner end of the inner side of the second disc.

### BACKGROUND OF THE INVENTION

1. Field of the Invention

The present invention relates to stator bobbins for axial winding.

2. Description of the Related Art

A conventional motor structure of fan includes a stator bobbin. As illustrated in FIG. 1 of the drawings, the conventional stator bobbin 90 comprises an upper pole plate 91, a lower pole plate 92, and an axle tube 93 mounted thereto. A space 94 is formed around a central hole of the stator bobbin 90 for receiving a winding 95. A shaft of a rotor 96 is rotatably mounted in the axle tube 93. A motor is thus constructed. The poles of the upper and lower pole plates 91 and 92 cooperate with a ring magnet 97 attached to the rotor 96. Since the winding 95 is uniformly distributed along the radial direction and since the magnetic flux is in proportion to the number of the turns of the winding, the number of the turns must be increased when it is desired to generate a larger magnetic flux. As a result, the height or diameter of the stator bobbin as well as the length of the winding must be increased in order to obtain a gain in the motor output torque for the purpose of increasing the output power of the motor.

### SUMMARY OF THE INVENTION

It is an object of the present invention to provide a motor stator bobbin including a first disc, a second disc, and a connecting tube that connects the first disc with the second disc. During formation of the winding, most of the winding is densely wound around the connecting tube in a manner that the turns adjacent to the connecting tube is denser such that a larger magnetic flux is generated when electricity is applied. Thus, the motor output torque is increased without adversely affecting the winding procedure of the motor.

In an embodiment of the invention, a stator bobbin for axial winding is made from insulating material and includes a first disc, a second disc, and a connecting tube that connects the first disc with the second disc. The connecting tube has a central hole and a space for winding is defined between the first disc and the second disc. A first pole plate is attached to an outer side of the first disc and a second pole plate is attached to an outer side of the second disc. A distance between an outer end of the inner side of the first disc and an outer end of the inner side of the second disc is greater than that between an inner end of the inner side of the first disc and an inner end of the inner side of the second disc.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is a sectional view of a motor with a conventional stator.

FIG. 2 is an exploded perspective view of a first embodiment of a stator bobbin in accordance with the present invention.

FIG. 3 is a sectional view of the stator bobbin in FIG. 2.

FIG. 4 is a sectional view of a second embodiment of the stator bobbin in accordance with the present invention.

FIG. 5 is a sectional view of a third embodiment of the stator bobbin in accordance with the present invention.

FIG. 6 is a sectional view of a fourth embodiment of the stator bobbin in accordance with the present invention.

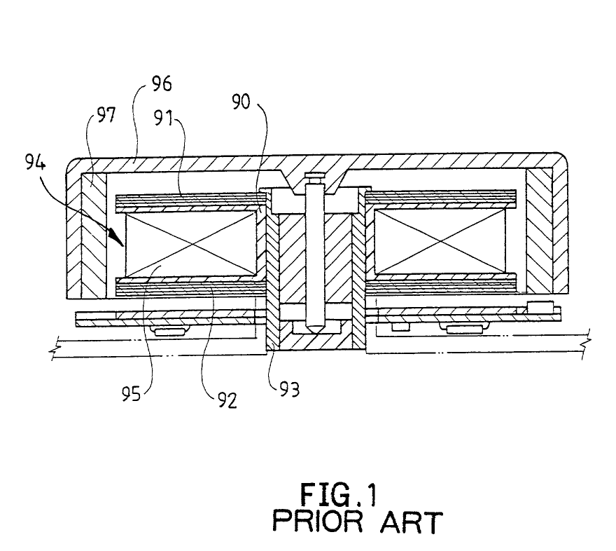

### DETAILED DESCRIPTION OF THE PREFERRED EMBODIMENTS

Preferred embodiments in accordance with the present invention will now be described with reference to the accompanying drawings.

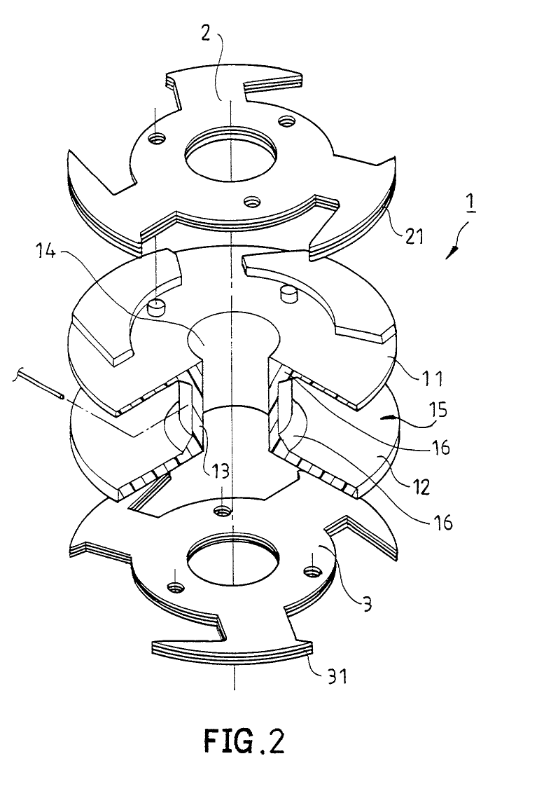

Referring to FIG. 2, a first embodiment of a stator bobbin 1 for axial winding in accordance with the present invention is made from insulating material (preferably plastics) and includes a first disc 11, a second disc 12, and a connecting tube 13 that connects the first disc 11 with the second disc 12. The connecting tube 13 has a central hole 14. A space 15 for winding is defined between the first disc 11 and the second disc 12. It is noted that an inner side of the first disc 11 and an inner side of the second disc 12 are not parallel to each other. In this embodiment, at least one of an inner end of the inner side of the first disc 11 and an inner end of the inner side of the second disc 12 has an inclined section 16 to thereby form a narrower section in the space 15 for winding. As a result, the distance between an outer end of the inner side of the first disc 11 and an outer end of the inner side of the second disc 12 is greater than that between an inner end of the inner side of the first disc 12 and an inner end of the inner side of the second disc 12.

A first pole plate 2 is attached to an outer side of the first disc 11 and a second pole plate 3 is attached to an outer side of the second disc 12. The pole plates 2 and 3 can be of any conventional shapes and structures. Each pole plate 2, 3 has poles 21, 31 for induction with a permanent magnet (not shown) on a rotor (not shown) for driving the rotor, which is conventional and therefore not described in detail.

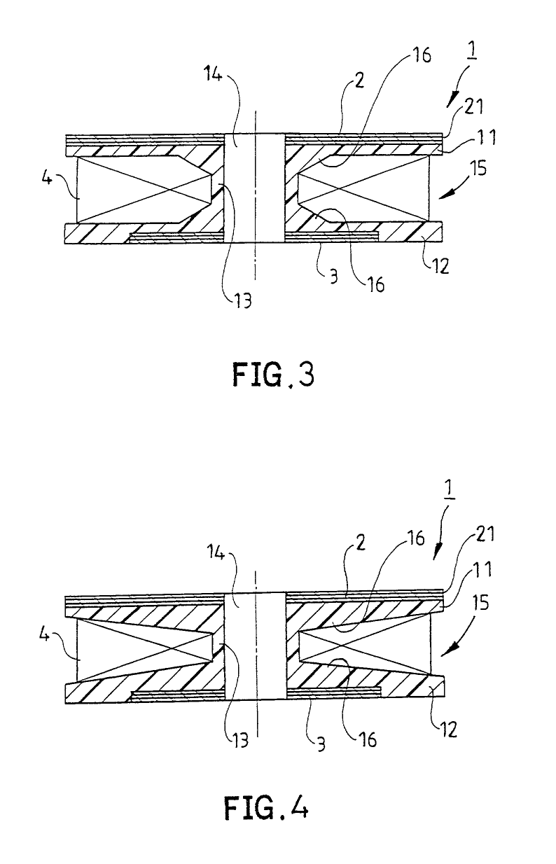

FIG. 3 illustrates the stator bobbin in an assembled state in which a winding 4 is wound in the space 15 of the stator bobbin 1. During formation of the winding 4 by means of winding wires reciprocatingly around the connecting tube 13, since a narrower section is defined in an inner end of the space 15 by the inclined sections 16 respectively formed on the inner ends of the inner sides of the first and second discs 11 and 12, the wires for forming the winding 4 will slide toward the connecting tube 13 when winding around the inclined sections 16. Thus, the winding 4 is denser in an area of the space 15 that is adjacent to the connecting tube 13. After the winding procedure, it is appreciated that the winding 4 wound around the connecting tube 13 at a place proximal to the connecting tube 13 is distributed in a manner denser than that wound around the connecting tube 13 at a place distal to the connecting tube 13. Thus, the stator bobbin 1 generates a larger magnetic flux after electricity is applied, thereby providing a gain in the motor output torque.

FIG. 4 illustrates a second embodiment of the stator bobbin I in accordance with the present invention. The stator bobbin 1 also includes a first disc 11, a second disc 12, and a connecting tube 13 that connects the first disc 11 with the second disc 12. The connecting tube 13 has a central hole 14. A first pole plate 2 is attached to an outer side of the first disc 11 and a second pole plate 3 is attached to an outer side of the second disc 12. A space 15 for winding is defined between the first disc 11 and the second disc 12. It is noted that at least one of an inner side of the first disc 11 and an inner side of the second disc 12 extends in a direction that is not perpendicular to a longitudinal axis of the central hole 14 of the connecting tube 13. In this embodiment, each of the inner side of the first disc 11 and the inner side of the second disc 12 is an inclined surface 16 to thereby form a space 15 that tapers radially inward. As a result, the distance between an outer end of the inner side of the first disc 11 and an outer end of the inner side of the second disc 12 is greater than that between an inner end of the inner side of the first disc 12 and an inner end of the inner side of the second disc 12. During formation of the winding 4 by means of winding wires reciprocatingly around the connecting tube 13, since the space 15 tapers radially inward due to provision of the inclined surfaces 16, the wires for forming the winding 4 will slide toward the connecting tube 13. Thus, the winding 4 is denser in an area of the space 15 that is adjacent to the connecting tube 13. After the winding procedure, it is appreciated that the winding 4 wound around the connecting tube 13 at a place proximal to the connecting tube 13 is distributed in a manner denser than that wound around the connecting tube 13 at a place distal to the connecting tube 13. Thus, the stator bobbin 1 generates a larger magnetic flux after electricity is applied, thereby providing a gain in the motor output torque.

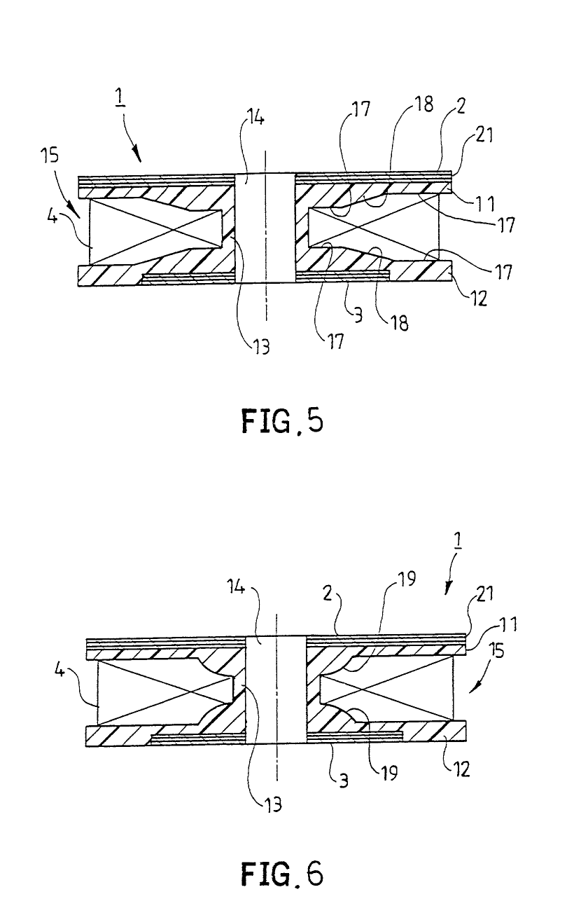

FIG. 5 illustrates a third embodiment of the stator bobbin 1 in accordance with the present invention. The stator bobbin 1 also includes a first disc 11, a second disc 12, and a connecting tube 13 that connects the first disc 11 with the second disc 12. The connecting tube 13 has a central hole 14. A first pole plate 2 is attached to an outer side of the first disc 11 and a second pole plate 3 is attached to an outer side of the second disc 12. A space 15 for winding is defined between the first disc 11 and the second disc 12. It is noted that at least one of an inner side of the first disc 11 and an inner side of the second disc 12 includes a number of sections having different slopes. In this embodiment, each of the inner side of the first disc 11 and the inner side of the second disc 12 includes at least two stepped sections 17 and a connecting section 18 between each two adjacent stepped sections 17. The stepped sections 17 are horizontal (namely, the stepped sections 17 extend in a direction perpendicular to a longitudinal axis of the central hole 14 of the connecting tube 13) and located at different levers. The connecting section 18 between the stepped sections 17 is an inclined surface or arcuate surface. As a result, the distance between an outer end of the inner side of the first disc 11 and an outer end of the inner side of the second disc 12 is greater than that between an inner end of the inner side of the first disc 12 and an inner end of the inner side of the second disc 12. During formation of the winding 4 by means of winding wires reciprocatingly around the connecting tube 13, the wires are firstly wound between the inner stepped sections 17, the connecting sections 18, and then the outer stepped sections 17. Thus, the winding 4 is denser in an area of the space 15 that is adjacent to the connecting tube 13. After the winding procedure, it is appreciated that the winding 4 wound around the connecting tube 13 at a place proximal to the connecting tube 13 is distributed in a manner denser than that wound around the connecting tube 13 at a place distal to the connecting tube 13. Thus, the stator bobbin 1 generates a larger magnetic flux after electricity is applied, thereby providing a gain in the motor output torque.

FIG. 6 illustrates a fourth embodiment of the stator bobbin 1 in accordance with the present invention. The stator bobbin 1 also includes a first disc 11, a second disc 12, and a connecting tube 13 that connects the first disc 11 with the second disc 12. The connecting tube 13 has a central hole 14. A first pole plate 2 is attached to an outer side of the first disc 11 and a second pole plate 3 is attached to an outer side of the second disc 12. A space 15 for winding is defined between the first disc 11 and the second disc 12. It is noted that at least one of an inner side of the first disc 11 and an inner side of the second disc 12 includes a convex section 19 that is connected to the connecting tube 13. As a result, the distance between an outer end of the inner side of the first disc 11 and an outer end of the inner side of the second disc 12 is greater than that between an inner end of the inner side of the first disc 12 and an inner end of the inner side of the second disc 12. During formation of the winding 4 by means of winding wires reciprocatingly around the connecting tube 13, the wires for forming the winding 4 will slide toward the connecting tube 13 due to provision of the convex sections 19. Thus, the winding 4 is denser in an area of the space 15 that is adjacent to the connecting tube 13. After the winding procedure, it is appreciated that the winding 4 wound around the connecting tube 13 at a place proximal to the connecting tube 13 is distributed in a manner denser than that wound around the connecting tube 13 at a place distal to the connecting tube 13. Thus, the stator bobbin 1 generates a larger magnetic flux after electricity is applied, thereby providing a gain in the motor output torque.

According to the above description, it is appreciated that the distance between an outer end of the inner side of the first disc 11 and an outer end of the inner side of the second disc 12 is greater than that between an inner end of the inner side of the first disc 12 and an inner end of the inner side of the second disc 12 by means of providing non-parallel inner sides of the first disc 11 and the second disc 12. Thus, when winding wires in the space 15 around the connecting tube 13, the wires will be guided toward the connecting tube 13 by the inclined sections or surfaces 16 or connecting sections 18 or convex sections 19. After the winding procedure, the winding 4 wound around the connecting tube 13 at a place proximal to the connecting tube 13 is distributed in a manner denser than that wound around the connecting tube 13 at a place distal to the connecting tube 13. Thus, the stator bobbin 1 generates a larger magnetic flux after electricity is applied, thereby providing a gain in the motor output torque without adversely affecting the winding procedure for the motor.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A stator bobbin for axial winding, the stator bobbin being made from insulating material and comprising:
a first disc including an inner side and an outer side;
a second disc including an inner side and an outer side;
a connecting tube connecting the first disc with the second disc to form a space for winding between the inner side of the first disc and the inner side of the second disc, the connecting tube including a central hole;
a first pole plate attached to the outer side of the first disc; and
a second pole plate attached to the outer side of the second disc;
wherein a distance between an outer end of the inner side of the first disc and an outer end of the inner side of the second disc is greater than that between an inner end of the inner side of the first disc and an inner end of the inner side of the second disc.

2. The stator bobbin as claimed in claim 1, wherein at least one of the inner end of the inner side of the first disc and the inner end of the inner side of the second disc is an inclined section that connects with the connecting tube.

3. The stator bobbin as claimed in claim 1, wherein at least one of the inner side of the first disc and the inner side of the second disc is an inclined surface such that the space for winding tapers radially inward.

4. The stator bobbin as claimed in claim 1, wherein at least one of the inner end of the inner side of the first disc and the inner end of the inner side of the second disc is a convex section that connects with the connecting tube.

5. The stator bobbin as claimed in claim 1, wherein at least one of the inner side of the first disc and the inner side of the second disc includes at least two stepped sections and a connecting section between each two adjacent said stepped sections, said at least two stepped sections extending in a direction perpendicular to a longitudinal axis of the central hole of the connecting tube and locating at different levels, the connecting section being one of an inclined surface and arcuate surface, said at least two stepped sections and the connecting section being so arranged that the space for winding tapers radially inward.
